(19) United States
(12) Patent Application Publication
(10) Pub. No.: US 2003/0038825 A1
(43) Pub. Date: Feb. 27, 2003

(54) Intuitive single key-press navigation for operating a computer

(75) Inventors: Sayling Wen, Taipei (TW); Kuang Shin Lin, Nan Kai (TW); Guei-Long Guo, Nan Kai (TW)

Correspondence Address: Mitchell P. Brook, Baker & Mckenzie, 12th Floor, 101 West Broadway, San Diego, CA, 92101-3890, US

(73) Assignee: INVENTEC CORPORATION

(21) Appl. No.: 09/938,791

(22) Filed: Aug. 24, 2001

(51) Int. Cl. G09G 5/00

(52) U.S. Cl. 345/700

(57) ABSTRACT

An intuitive single key-press navigation system is disclosed for operating a computer running an application software program by a user under a host operating system. The navigation system comprises a user interface and a kernel unit. The user interface comprises a user interface module for providing interface between the computer and the user by issuing interface requests during the use of the application software program by the user. The user issues the interface requests by pressing a single key on the keyboard of the computer responding to discrete options menus presented to the user by the application software program. The kernel unit comprises an interface database module for storing text-based program options information for the application software program; an interface graphics module for storing graphics information for the application software program; an interface response module for receiving the interface requests issued by the user; and an interface generator module receiving the text-based program option information and the graphics information and generates visual-effect symbols for presenting to the user based on the text and graphics information under the issued interface requests.

### FIELD OF THE INVENTION

This invention relates in general to the navigation of computer operation in application software programs and, in particular, to an intuitive single key-press navigation system for operating a computer running application software programs for computer novice users.

### BACKGROUND OF THE INVENTION

Conventional operating systems (OS) for personal computers (PC) such as commercial Microsoft Windows (and CE) and freeware Linux are in general full-fledged operating systems capable of many and various functionalities. Feature-rich and sophisticated they may be, however, those very features and sophistication themselves also constitute, on many occasions, serious psychological barriers for computer-novices. These barriers automatically arise for many novice users as they attempt to use the computer not only because the typical PC OS is complex and feature-laden, but also because there are at least several procedural steps to take before any of the more simple and intuitive computer applications can be launched and used.

To power up a computer and bring up an application, a user has to boot up the system, access the physical interface of the system via devices such as a keyboard and/or mouse, locate the whereabouts of the particular application software from the desktop icon array, and then actually launch the application.

Even after the user has successfully brought the desired software application up and running, the process of using the application will most likely involve interacting with the application via one or more of several forms of user interfaces. Sometimes, a combination of these interfaces will have to be used. Typical of these user interfaces are graphical (GUIs) and multimedia types initiated through the use of a mouse, keyboard, microphone, and the like. However, since almost all of the most popular software application programs are marketed in English versions, and even the non-English version software programs inevitably contain English messages in the interfaces they provide, for non English-speaking or barely literate users, even these popular GUIs and other multimedia interfaces constitute obstacles to computer access and productive use.

Thus, an easy-to-use computer application software system should look and feel friendly and be encouraging rather than frightening. A friendly and encouraging application system should be fool-proof in that the user knows he or she will never physically damage the computer, crash the OS, or lose data simply by attempting different commands on the computer. A simple computer application system is therefore desirable for those intending to learn and use computers for the first time and then for simple daily activities such as keeping phone numbers and addresses, web browsing, and many other intuitive applications.

### SUMMARY OF THE INVENTION

An easy-to-use application software system aimed at providing hands-on experience and initiating the learning of computer use for computer novices has the functionality for processing daily-life computer applications that a computer-novice desires. Functionalities provided by such an easy-to-use application software system include the ability to process handy personal information such as phone numbers and addresses, take notes in texts or in drawings, provide basic communication services including telephone, facsimile, electronic mailing, chatting service over the network, and access to the popular World Wide Web over the Internet. The system also provides easy-to-use application systems for convenient learning and recreational sessions such as tutoring for personal skills such as language and typing, game playing, as well as audio and video playback.

The present invention provides an intuitive navigation system for application programs that works in a cooperative manner with a normal full-feature OS in order to provide user friendliness and an encouraging mood for computer novices or even illiterates.

As users access PC software services, typical interface provided by the application software is GUI. For an experienced computer user, navigation via the use of a pointing device such as the conventional mouse in application software programs does not constitute problem even if a program is new to the user. However, for computer novices, this is not the case. The convenience of a mouse that it can easily point at anything on the virtual desktop of an application simply, in most occasions, confuses computer novices. For a novice, the different pointing symbols of a mouse as it points to different icons, menu items or the like that an application uses to interface the user simply complicates the entire matter of computer use.

For example, the typical default arrowhead pointer in a Microsoft Windows desktop can be reconfigured to the hand-shaped pointer that appears almost the same as the pointer when it points to a hyperlink in a web browser session. This is all right for an experienced computer user but becomes confusing for a novice. Such confusion, in many occasions, shies away a novice. Therefore, what is efficient and intuitive for the use of the conventional GUI via mouse by experienced computer users is not necessarily true for most novice users. On the other hand, although in most application software GUIs, many of the point-and-click actions on a pointing device have their corresponding equivalent key-press activation sequences, however, such sequences are not clearly known to the user.

It is therefore an objective of the present invention to provide an intuitive single key-press navigation system for operating a computer that provides easy navigation during the use of the software services provided by a computer.

It is another objective of the present invention to provide an intuitive single key-press navigation system for operating a computer that allows for easy navigation during the use of the software services provided by a computer without the use of a pointing device.

The present invention achieves the above-identified objectives by providing an intuitive single key-press navigation system for operating a computer running an application software program by a user under a host operating system. The navigation system comprises a user interface and a kernel unit. The user interface comprises a user interface module for providing interface between the computer and the user by issuing interface requests during the use of the application software program by the user. The user issues the interface requests by pressing a single key on the keyboard of the computer responding to discrete options menus presented to the user by the application software program. The kernel unit comprises an interface database module for storing text-based program options information for the application software program; an interface graphics module for storing graphics information for the application software program; an interface response module for receiving the interface requests issued by the user; and an interface generator module for receiving the text-based program option information and the graphics information and generating visual-effect symbols for presenting to the user based on the text and graphics information under the issued interface requests.

In a computer running an application software program by a user under a host operating system wherein the application software program comprises a user interface and a kernel unit; the user interface comprises a user interface module for providing interface between the computer and the user by issuing interface requests during the use of the application software program by the user; and the kernel unit comprises an interface database module for storing text-based program options information for the application software program; an interface graphics module for storing graphics information for the application software program; an interface response module for receiving the interface requests issued by the user; and an interface generator module for receiving the text-based program option information and the graphics information and the graphics information and generating visual-effect symbols for presenting to the user based on the text and graphics information under the issued interface requests; the invention further provides an intuitive single key-press navigation method for navigating said computer comprising the steps of: 1) generating a menu of options containing a number of visual-effect symbols each representing one of the options based on the text and graphics information under the issued interface requests for selection by the user; 2) the user selecting one of the options by performing a single key-press selection by pressing a single key on the keyboard of the computer; and 3) navigating through the application software program by implementing the single key-press selection at least one time.

### BRIEF DESCRIPTION OF THE DRAWINGS

Other objects, features, and advantages of this invention will become apparent by way of the following detailed description of the preferred but non-limiting embodiments. The description is made with reference to the accompanying drawings in which:

FIGS. 1A-1C are selected screen shots of an embodiment of the intuitive single key-press computer application navigation system of the invention in the process of utilization by a user;

FIG. 2 is a diagram schematically illustrating the program flow of a embodiment of the software system of the invention in the process of the single key-press program navigation;

FIG. 3 is a block diagram illustrating an embodiment of the software system configuration for the intuitive single key-press computer application software navigation system of the invention;

FIG. 4 is a flowchart illustrating the program flow implemented by the interface generator module for the software system of FIG. 3;

FIG. 5 is a flowchart illustrating the program flow implemented by the interface response module for the software system of FIG. 3;

FIG. 6 is a tree diagram illustrating an example requirement in a typical language tutoring session;

FIGS. 7 and 8 are screen shots of the intuitive single key-press computer application navigation system of the invention constructed to meet the need for the language tutoring session outlined in FIG. 6; and

FIG. 9 is a screen shot of another embodiment of the intuitive single key-press computer application navigation system of the invention in a graphics access service session.

### DESCRIPTION OF THE PREFERRED EMBODIMENTS

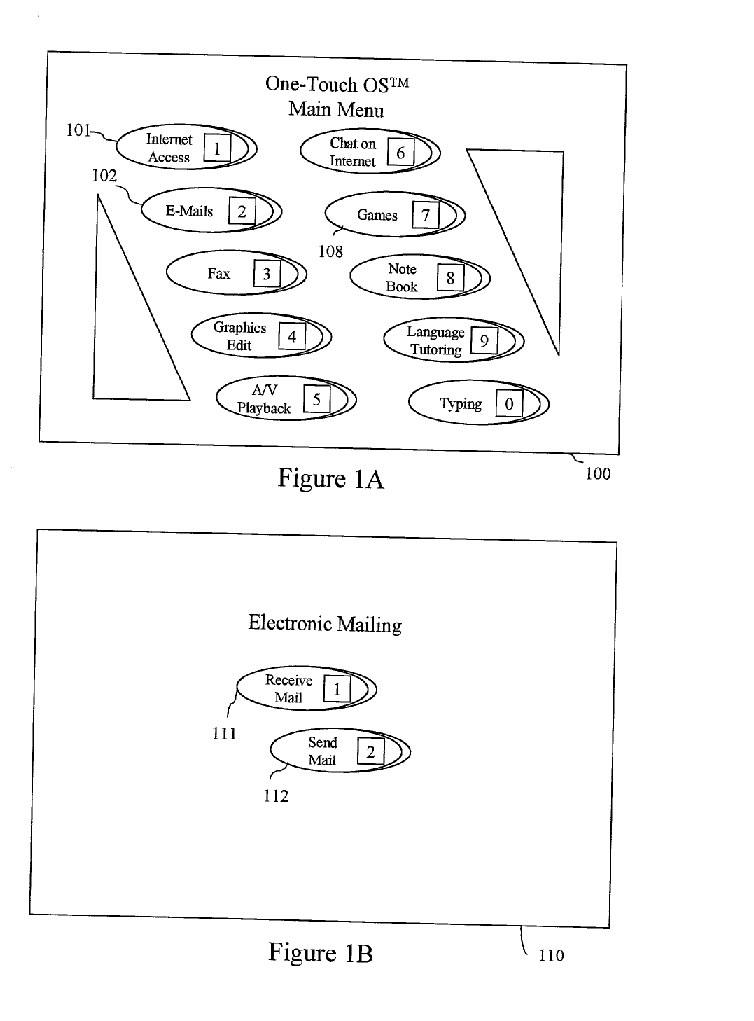

FIGS. 1A-1C are selected screen shots of an embodiment of the intuitive single key-press computer application navigation system of the invention in the process of utilization by a user. In a typical embodiment, the intuitive navigation system for application programs of the invention works in a cooperative manner with a normal full-feature OS in order to provide user friendliness and an encouraging mood for computer novices or even illiterates. The full-feature OS may, for example, be Microsoft Windows OS (and CE) while the application program featuring the inventive navigation system may, for example, be the One-Touch OS™ published by the assignee of the present invention.

The One-Touch OS™ is a user-friendly and easy-to-use software application program for the convenience of computer novices. The basic software design idea of the One-Touch OS™, as the name implies, is one-touch actuation of software functionalities. Such simple actuation interface is preferred by the majority of computer novice users. The one-touch actuation can be the single-press of a key on the keyboard of the computer. In an example of such an easy-to-use One-Touch OS™ application software, different sets of suitable keys of the keyboard can be assigned for different functionalities of the particular computer application. The principle for these key assignment is simplicity and clarity for computer novices.

An example of such a One-Touch OS™ features many daily-life computer applications aimed at providing hands-on experience and initiating the learning of computer use for computer novices. It has the functionality for processing daily-life computer applications that a computer-novice desires. Functionalities provided by such an easy-to-use application software system include the ability to process handy personal information such as phone numbers and addresses, take notes in texts or in drawings, provide basic communication services including telephone, facsimile, electronic mailing, chatting service over the network, and access to the popular World Wide Web over the Internet. The system also provides easy-to-use application systems for convenient learning and recreational sessions such as tutoring for personal skills such as language and typing, game playing, as well as audio and video playback.

FIG. 1A exemplifies the main screen 100 of a user-friendly application program such as the One-Touch OS™. As a user launches the application program under an OS such as the Microsoft Windows, the main screen illustrated in FIG. 1A provides the user with a number of daily functionalities suitable for implementation on a computer. For example, the application program may provide access service to the Internet such as Web browsing, electronic mailing, chatting, and even game playing over the Internet. Of course, games may also be played on the local machine. Also, services such as note-taking, and language tutoring are also possible.

All these functionalities can be started via the single press of a key on the keyboard of the personal computer hosting the application program. For example, each of the numeric keys 1-10 of the keyboard may be assigned to one such functionalities: The virtual numeric key 1 as represented by the visual-effect symbol 101 activates web browsing, key 2 102 allows for access to electronic mails, key 8 108 for taking personal notes, and so on. All the services are clearly outlined on the display screen 100 of the computer, with a visual-effect symbol signifying the push button that bears a numeric number next to the corresponding functionality intended. For example, in FIG. 1A, the visual-effect item as identified by reference numeral 102 indicates to the user that the press on the numeric key 2 on the keyboard allows for access to the electronic mail services. Note, of course, that both the number keys on the typing area and the numeric keypad may be arranged by the application program to be applicable for the single-press activation of the intended computer functionality. Such an intuitive arrangement of function subprogram-launching within the main application program allows an intuitive interface for access by the user of the personal computer.

Then, as the user selects a function, the electronic mail services activated by numeric key 2, i.e., symbol 102 in the screen 100 of FIG. 1A, for example, the user may be guided further to the next step of his or her electronic mailing session, as is illustrated in FIG. 1B. Typical in an electronic mail service are at least two activities: the sending and receiving of electronic mails. The user, again, may select his or her desired electronic mail service by the single-press of a numeric key, either key 1 represented by the visual-effect symbol 111 or 2 by symbol 112 in the illustrated example of screen 110 of FIG. 1B. In the example, visual symbol 111 on the screen 110 prompts the user for the selection of mail reception while 112 for sending. These are clearly presented to the user by the visual-effect push buttons labeled with numbers 1 and 2 respectively in visual effect items 111 and 112.

As the user navigates further into his or her electronic mail session by, for example, selecting the reception of mails via the single-press of numeric key 1 as symbolized by the visual key 111 in the screen 110 of FIG. 1B, a third screen 120 comes up as illustrated in FIG. 1C to present the user with the mails already reaching into the user's mail box. Again, numeric keys may be used for the user's selection of which of the received mails he or she wishes to read. In FIG. 1C, visual effect item 121 identifies the first received mail in the list, 122 the second, and so on. A single-press of the suggested numeric keys would open the selected mail for user's review.

In the above-described process of single-press application software navigation, numeric keys on the computer keyboard are used as an example. Other keys, however, may also be used. For example, function keys F1-F12 on a typical personal computer keyboard may also be suitable. In general, numeric and function keys that are numbered in sequence are suitable for presenting a group of selection of functions to a user in the most intuitive manner. They become the organized “hot-keys” for many of the computer applications most used daily.

These hot-key arrangements assist in acquainting a novice computer user to how the typical application software programs are typically used in the typical personal computers. Further, among different application programs provided by software systems such as the One-Touch OS™, these hot-key organizational assignments may be arranged to be the same for similar functionality subprograms. For example, for both the electronic mail sending and receiving functions, the selection of listed mail messages can be implemented using the same numeric or function key assignments. This further helps in acquainting a user to the computer use.

The sequence of single-pressing of keys as suggested by different program screens obviates a novice user's need to key-press a combination of, for example, “Alt-F1” or even “Ctrl-Alt-Shift-Esc” in many application programs. Moreover, the use of visual-effect symbolizing graphical items on the menu screens of an application program such as the One-Touch OS™ that suggests directly to the user how the functionality can be selected is a most intuitive interface to a novice computer user.

In an intuitive single key-press navigation system for computer operation in accordance with a preferred embodiment of the invention, the keys organized for single-press activation of program function in various stages of an application software can be categorized as fundamental and auxiliary keys. The fundamental keys are defined to be keys that implement basic program navigation in the process of application software use by a computer user. In general, the fundamental keys include function keys F1-F12, numeric keys 0-9, the left, right, up and down arrow keys, the Enter, the Esc, and the Page-Up and Page-Down keys on the typical PC keyboard. Auxiliary keys, on the other hand, are those used for correcting and altering purposes as a user navigates through a software session. They include the BackSpace key, the plus “+” and minus “−” keys, the Home and End keys, and the insert “Ins” and delete “Del” keys. These fundamental and auxiliary key categorizations are most intuitive for the majority of novice users as they use daily-life software programs on a typical PC.

Note that although pointing devices such as mouse and touch pen (of pen-based input systems) are not necessary to use the intuitive single key-press navigation system of the invention, they are, however, compatible with the navigation system of the invention. In other words, a user may also employ a mouse to activate the single-keys presented in application screens as symbolizing visual items. Further, voice interface and remote control devices may also be integrated, although not necessarily, into a navigation system of the invention as supplemental interfaces.

In general, in the intuitive navigation system of the invention for an application software program, the One-Touch OS™ for example, the function keys of the fundamental category may be assigned for activating the provided major functionalities. Deeper into the program session, numeric keys can be used for the selection of items required in the implementation of the application program. On the other hand, auxiliary keys may be used to alter selection of program items or functions within a screen of menu presented to a user.

For example, in a likely scenario of use of application software program such as the One-Touch OS™ by a novice user, the left and right arrow keys of the fundamental group of keys can be used to alter or select among a group of program functionalities presented to the user. Up and down arrow keys, on the other hand, can be used to select among an entire group of options presented to the user. The Esc key can be used to return the program navigation back to a shallower level of the application program session. Enter key is most frequently used to confirm the selection of options as presented to and selected by the user. The Page-Up and Page-Down keys are suitable for flipping through the pages of options presented by an application program that are more than one screen. Other functional operations not common to most application software programs may be activated by the auxiliary keys as the need arises.

During the process of program navigation using principally the fundamental keys, if the user should decide to alter or correct the selection of a program functionality, the proper one of the auxiliary keys or a combination of them can be used. For example, while conducting an e-mail session provided by an application program such as the One-Touch OS™, the user can alter or correct his or her entering of a new e-mail address for a mail-sending functionality by using the auxiliary “Ins” and/or “Del” keys to edit the address. In the process, “Home” and “End” keys can be used to jump to the start and end of the address string conveniently.

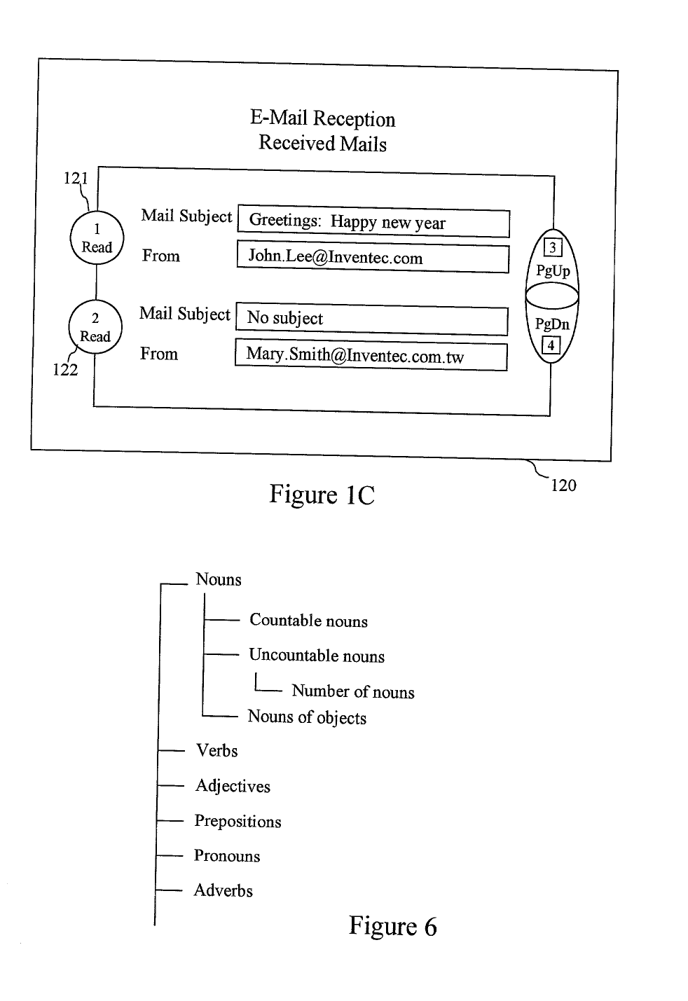

FIG. 2 is a diagram schematically illustrating the program flow of an embodiment of the software system of the invention in the process of the single key-press program navigation. In the program flow of an application software, a user may be presented with a sequence of single key-press menus 210, 220 and 230 at different stages of the program execution.

For example, in an application software system such as the One-Touch OS™ that provides daily-life computer applications, at the initial stage of program execution, the user is presented with the single key-press menu 210 allowing for selection from a host of the principle applications offered by the application. If the user wishes to activate, for example, the game activity that is activated by, for example, the seventh function key F7 as identified by reference numeral 212, the program then guides the user to a second level of single key-press menu 220 once F7 is pressed. In the menu 220, different categories of games, for example, simulation, role-playing, chess and a lot of others may be arranged in the menu system. If the F9 key is pressed to select, for example, flight simulation games, the program then proceeds to present the user with a collection of various flight simulation programs, as is outlined in the sub-menu 230. In the options menu 230, the user may select the desired simulation program to play via pressing on the specific numeric key 233 representing that particular simulation.

Thus, as the user is guided through the different program execution stages of an application software, different single key-pressing actions are suggested along the session to finally obtain the desired program service. The user, in general, based on the desired program functionality, engages selection on the presented menu in the process, is free from confusion that might mislead the user to a situation in which the user is lost and the desired program service can not be accessed efficiently and quickly. Also, both function keys and numeric keys can be used for the program navigation.

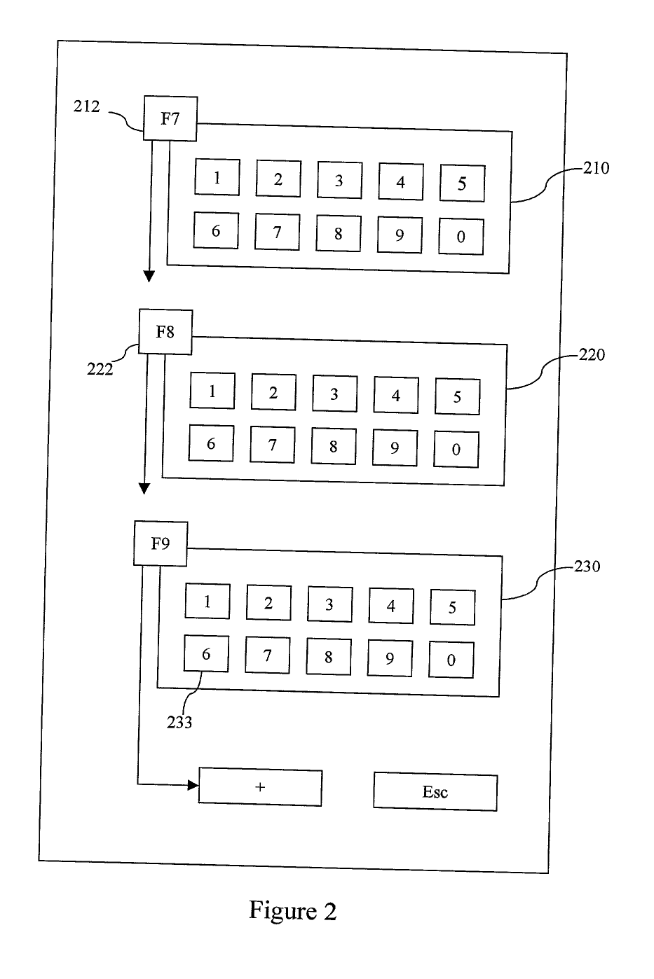

FIG. 3 is a block diagram illustrating an embodiment of the software system configuration for the intuitive single key-press computer application software navigation system of the invention. The navigation system 300 comprises a kernel unit 310 and a user interface 320. In such a navigation system 300, a One-Touch OS™ for example, the kernel unit 310 of the system receives and responds to requests issued by the user 321 from the user interface 320 for the program navigation. A user interface module such as the One-Touch OS™ UI module 322 is responsible for providing the interface between the computer and the user. The interface requirements are transferred to the kernel unit 310 for processing.

The kernel unit 310 is comprised of an interface database module 311, an interface graphics module 312, an interface generator module 313, and an interface response module 314. The interface database module 311 holds information in relation to the program options for the application software, and the interface graphics module 312 holds graphics information used for the construction of graphical interface to be presented to the user in the various stages of program flow.

Normally, graphics information includes those required for the generation of visual-effect symbols such as numbered keys to be shown on the program menu screens for users selection. Information held in interface database module 311 includes those required for the labeling of the visual-effect symbols. As an example, consider a visual push button presented to the user of the computer that selects the electronic mail reception service. The construction of this visual-effect interface would require the graphics information of a push button in module 312, and the text information of “email reception” on numeric key “1” in module 311. Such a generated visual push button shown on the computer screen identifies itself to the user for the activation of “email reception” functionality.

The interface response module 314, responding to the request issued by the user 321 and relayed by the user interface 320 of the user interface 320, transfers the interface generation request to the interface generator module 313. Based on the received requests, the generator module 313 generates the visual-effect symbols on the computer screen in accordance with text and graphics information retrieved from the interface database module 311 and the interface graphics module 312 respectively.

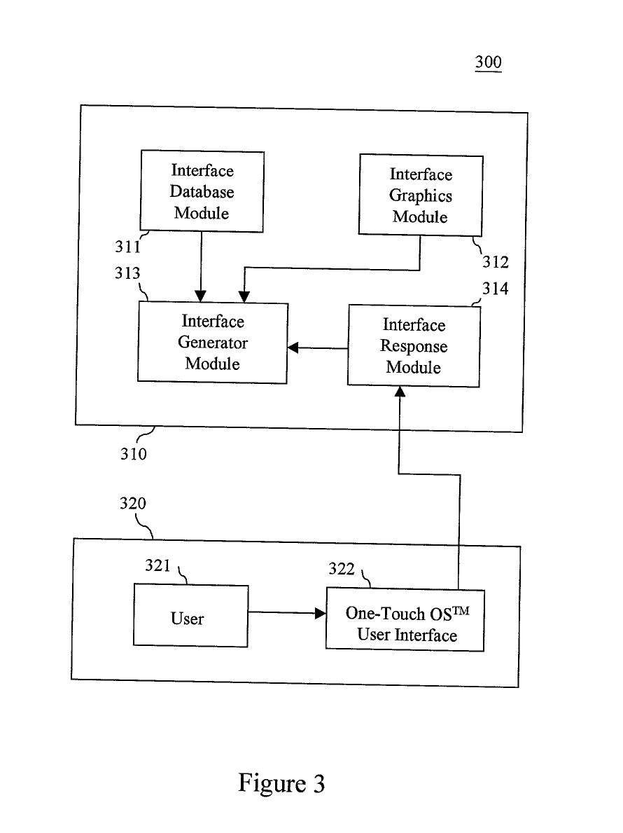

FIG. 4 is a flowchart illustrating the program flow implemented by the user interface generator module 313 for the software system 300 of FIG. 3. The process starts at step 401 and the program reads in text and graphics information at step 402 for the interface. In the process, this text information is kept in the temporary storage at step 403. Then, at step 404, the process generates one element of the interface requested. This element may, for example, be a visual push button among the many push buttons to be generated for one menu screen to be presented to the user. At step 405, the process then checks to determine if all graphic elements are completed. If not, the process returns to step 404 for the generation of the next element. If yes, the process concludes at step 406.

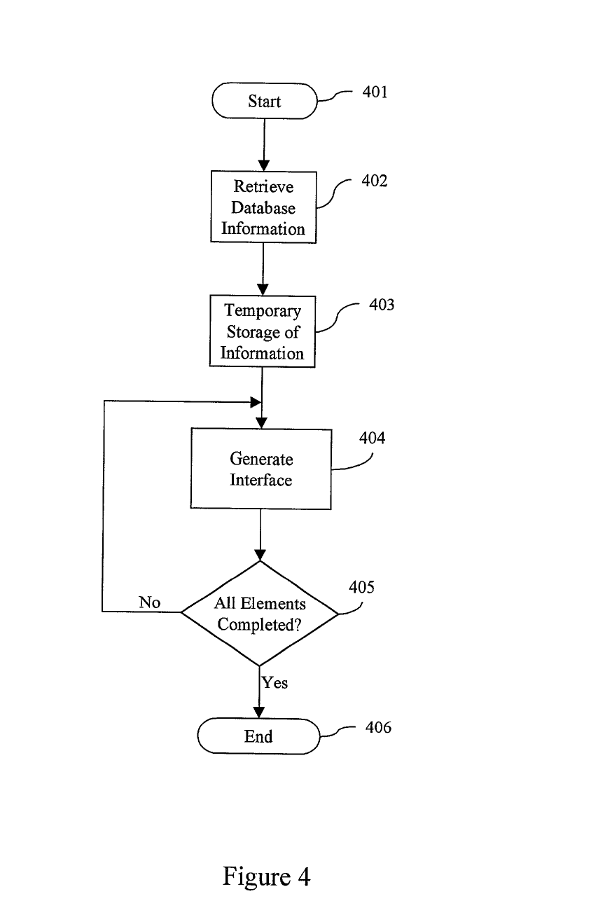

FIG. 5 is a flowchart illustrating the program flow implemented by the interface response module 314 for the software system 300 of FIG. 3. The interface response module 314 of the software system 300, in general, starts a program cycle that awaits input from the user of the application software at step 501. The input is, in a One-Touch OS™ application system for example, normally a key-press input issued by the user as he or she accesses the computer services. Upon receipt of an input, at step 501, the program inspects to determine what type of input it has received at the decision-making step 502.

In an embodiment of the navigation system of the invention, one of three types of user input is possible. In a first situation in which one of the function keys is pressed, the program flow proceeds to step 503 to further check and determine if the key-press represents the request for a sub-menu. If yes, that particular sub-menu is activated in step 506 for the user's further selection. If not, the program proceeds to step 507 in order to directly activate the functionality represented by the user key-press. After activation of the selected functionality, the program flow returns to step 501 to await another of the user's input.

If the decision-making step 502 determines that the user request issued at step 501 is a directional arrow key, the program then determines at step 505 which direction is in fact issued. Based on the issued directional arrow key, the selection of program function can be switched among the same single key-press menu level, and the program returns to step 501 to await the next of the user's input.

If, on the other hand, the decision-making step 502 determines that the user request issued at step 501 is a numeric key, the program branches to step 504, in which the program determines if the selected option offers another sub-menu, or just a group of options. The program displays the sub-menu or option group accordingly and awaits for the user's selection. Once the user issues a selection, the program processes accordingly and returns the control back to step 501 to await for another of the user's input.

The program flow outlined in FIG. 5 and described above is, in general, a software program control loop constituting major and sub loops. The major program loop provides options to the user, at step 502 of the flowchart of FIG. 5, including a group of major categories of functionalities in an application software programs such as the One-Touch OS™. The user may implement his or her selection of, for example, either the electronic mail or the web browsing service utilizing the up/down/left/right arrow keys from the fundamental key group in the major program loop. Once the main category of program functionality is determined, the user may again be engaged in a sub program loop to decide on, for example, either to receive or send mail in a mail session. All the selections may be signified to the program by the “Return” key of the fundamental key group.

Thus, utilizing a sequence of single key-presses, the intuitive single key-press navigation system for application programs as disclosed by the present invention is capable of guiding a novice user through complicated program process flows in the process of application software use. These single key-presses are clearly suggested iris by the navigation system duly in course of program flow. The suggestions, as mentioned, can be explicitly and neatly arranged in a series of program menus as the software program develops itself in the process of implementation of daily-life computer services such as Internet access and note-taking, to name a few. The entire process is free from the use of pointing devices such as mouse, or, confusing key combinations only familiar to computer-experienced users. In the following paragraphs, a substantial example of application of the navigation system of the invention is described to further explain the advantages of the inventive navigation system.

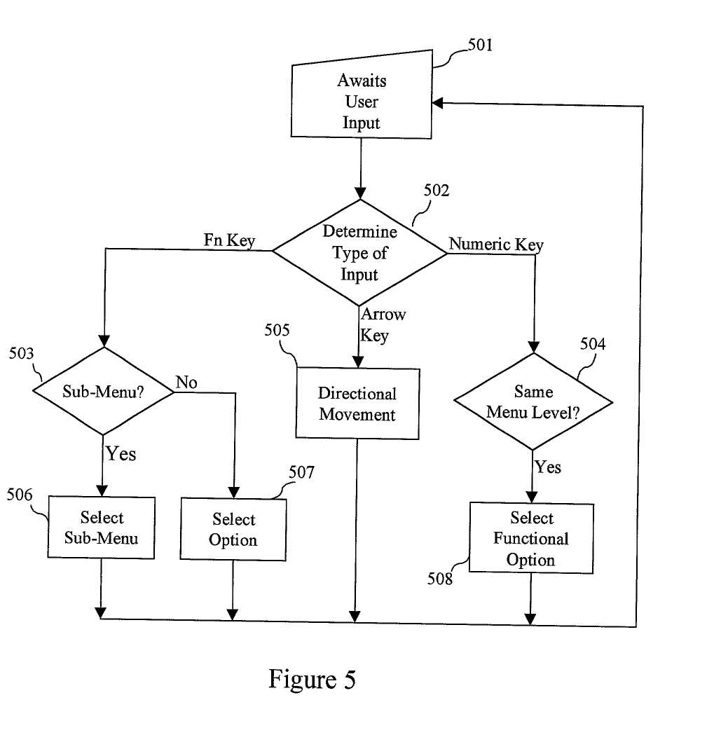

FIG. 6 is a tree diagram illustrating an example of process interfacing requirements in a typical language tutoring session. The example considers the situation is which a user is using a PC to conduct a language-tutoring session under an application software such as the One-Touch OS™. As is exemplified in FIG. 6, a typical language tutoring session presents words of different grammatical classifications in a tree-shaped hierarchical system. For example, when referring to nouns, countable and uncountable nouns as well as other characteristics of nouns can and should be discriminated. There are other similar or dissimilar distinctions among other word classifications such as verbs and prepositions of a language. Without proper organization, this is complicated and confusing to explain in a language tutoring software.

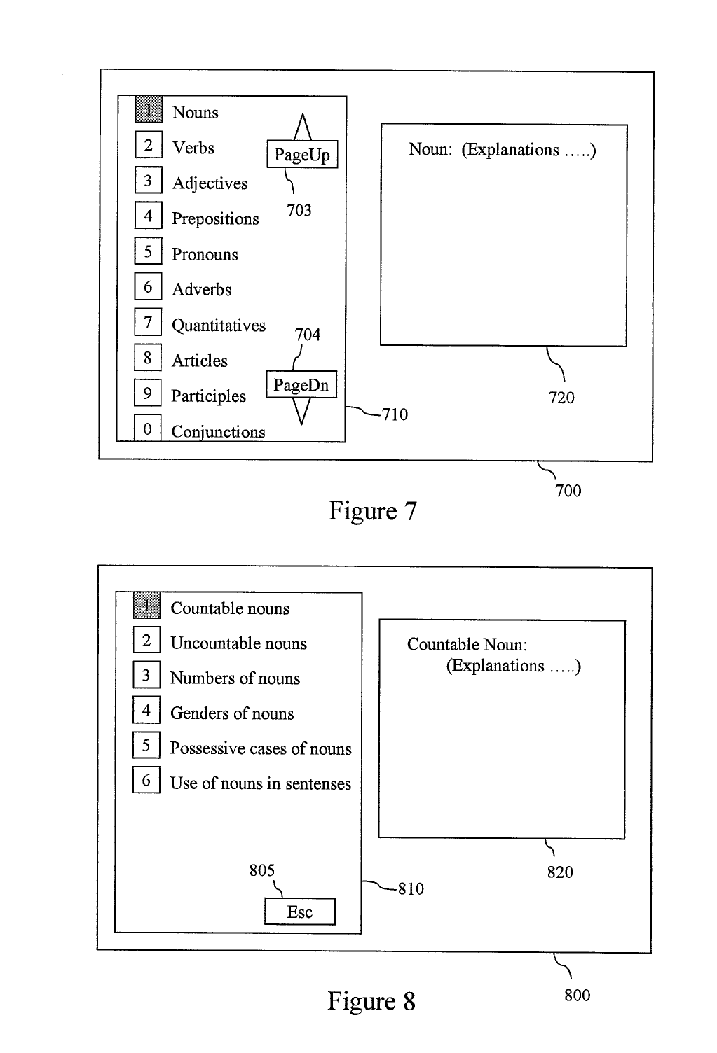

FIGS. 7 and 8 are screen shots of the intuitive single key-press computer application navigation system of the invention constructed to meet the needs for the language tutoring session outlined in FIG. 6. When the tutoring program is started, as is illustrated in the screen shot of FIG. 7, a first level of menu 700 is presented to the user of the language tutoring program. In accordance with an embodiment of the invention, this first menu level may present all the word classifications to the users for selection in order to research into the details of each of the classifications.

In the example of FIG. 7, as the user looks at the listing 710 of the word classifications provided at the left of the screen 700, the highlighted class, nouns for example, may have an explanation presented in the right column, 720, of the screen. As the user navigates through the word classes in column 710 using, for example, his arrow keys on the computer keyboard, the explanation of the selected word class may be conveniently found at the right column 720 of the screen.

In case that more than a column of ten classes as represented by the ten numeric keys 0-9 are in existence, the auxiliary keys such as Page-Up key 703 and Page-Down key 704 can be used to display another group of word classes, much like flipping pages of a book.

As the user of the tutor program decides to look further into details of one particular word class, noun for example again, the corresponding function or numeric key of the fundamental group can be pressed on the keyboard. The navigation system, in response to this activation, presents another screen displaying details of the selected word class, as is illustrated in FIG. 8.

Here, note that further detailed classification, if applicable, may be organized for the user. For example, in the case of learning nouns, details such as countable and uncountable nouns, the use of quantity in relation to nouns, gender of nouns, as well as other characteristics concerning nouns in a language can be outlined in the menu, the left column 810 for example, that allows a user's selection for further explanations. Again, the highlighted item in column 810 can bear an explanation in the right column 820. And, if the user desires, the session can be returned to the upper level of word classification via the single-press of an auxiliary key, the Esc key 805 for example.

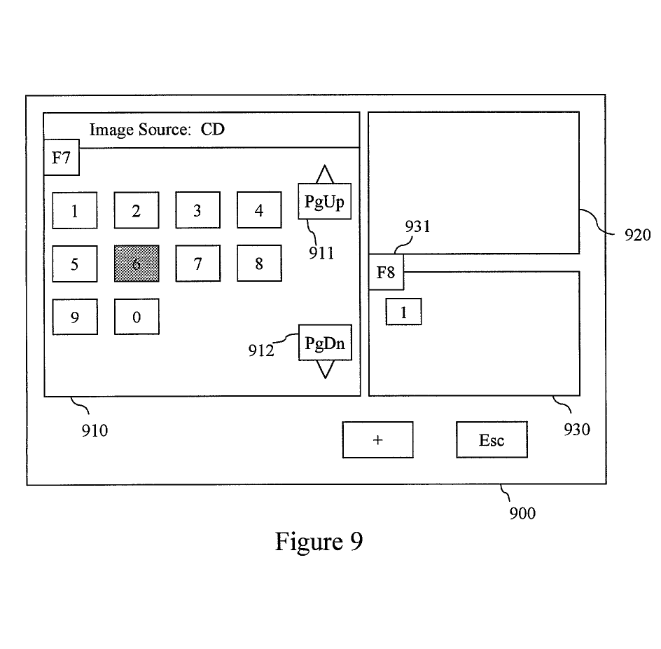

Thus, with a the intuitive single key-press navigation system of the invention, software application programs featuring complex functionalities can be conveniently navigated even by a novice computer user. Single key-presses at different phases of the session of an application program navigates the user along the development of the application session. In the process, confusions are reduced to a minimum as all phases of the program session are guided via the use of clearly organized menus. As another example in addition to the language tutoring described above, consider FIG. 9 of the drawing.

FIG. 9 is a screen shot of another embodiment of the intuitive single key-press computer application navigation system of the invention employed in a graphics access service session. In a daily-life convenience application software such as the One-Touch OS™ that provides various handy computer application functionalities, consider the situation in which graphic images are to be edited in certain photograph albums. Such editing, as is imaginable, involves the addition of graphic images of origins such as CD and floppy disks into the digital electronic photo album residing on a PC. With the intuitive single key-press navigation system of the invention, this type of effort becomes easy for even computer novice users.

First, a user attempting to access the graphics processing functionality such as provided by the One-Touch OS™ may select the source for the graphic information, a CD for example. The program presents a graphic image selection menu to the user in the image area 910 of the computer display screen 900. Each of the accessible images from the CD is presented as a small but recognizable icon in the screen area 910 and designated by a corresponding numeric key identification. When numeric keys are used, ten images are presented for selection at most at the same time. If more then ten images are in existence, auxiliary keys such as Page-Up 911 and Page-Down 912 can be used to access more of them.

In another area of the computer screen, to the right for example, a window 920 large enough to provide a preview of the highlighted image with sufficient details can be used for the user's examination. This allows the user to have a better look at the candidate image than the tiny icons in screen area 910.

In yet another area of the computer screen, to the lower-right for example, another window 930 can be used to display the selected image. In an embodiment, a user may enter this windows via the single key-press of the function key, F8 key 931 as outlined in the drawing for example. Even if an image is selected in this process, the user can still abort selection via preset single keys in an editing screen not shown in the drawing. When, however, the selection is confirmed by the user, the image can be added into the digital album to conclude the session of an image selection for a photographic album.

In summary, the navigation of application software program that is intuitive for computer novices in accordance with an embodiment of the invention can be summarized in at least the following steps. First, a menu of options is generated that contains a number of visual-effect symbols each representing one of the options based on the text and graphics information under the issued interface requests for selection by the user. Then, the user may select one of the options by performing a single key-press selection by pressing a single key on the keyboard of the computer. And, this single key-press operation may be needed to be performed at least once in the process of accessing the desired service provided by the application software program.

Thus, by employing a limited number of keyboard keys as organized sets of hot keys for software application programs in different phases and/or stages of an application, the program navigation can be accomplished by the press of a series of single hot keys shown clearly on the computer screen. This is particularly suitable and encouraging for novice computer users.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. An intuitive single key-press navigation system for operating a computer running an application software program by a user under a host operating system, said navigation system comprising:
a user interface comprising a user interface module for providing interface between said computer and said user by issuing interface requests during the use of said application software program by said user; said user issuing said interface requests by pressing a single key on the keyboard of said computer responding to discrete options menus presented to said user by said application software program; and
a kernel unit comprising an interface database module for storing text-based program options information for said application software program; an interface graphics module for storing graphics information for said application software program, an interface response module for receiving said interface requests issued by said user; and an interface generator module receiving said text-based program option information and said graphics information and generating visual-effect symbols for presenting to said user based on said text and graphics information under said issued interface requests.

2. The application software navigation system of claim 1, wherein said visual-effect symbols are representations of push buttons displayed on the screen of said computer.

3. The application software navigation system of claim 1, wherein said application software program is a user-friendly application software system incorporating a plurality of simple interfaces for intuitive access by computer users.

4. The application software navigation system of claim 1, wherein said application software program is a user-friendly One-Touch OS application software system for processing daily-life computer applications for computer users.

5. The application software navigation system of claim 4, wherein said One-Touch OS application software system processes handy personal information including phone numbers and addresses.

6. The application software navigation system of claim 4, wherein said One-Touch OS application software system takes notes.

7. The application software navigation system of claim 4, wherein said One-Touch OS application software system provides communication services.

8. The application software navigation system of claim 4, wherein said One-Touch OS application software system provides chatting service over the Internet.

9. The application software navigation system of claim 4, wherein said One-Touch OS application software system provides access to the World Wide Web over the Internet.

10. The application software navigation system of claim 4, wherein said One-Touch OS application software system provides language tutoring to computer users.

11. The application software navigation system of claim 4, wherein said One-Touch OS application software system provides typing tutoring to computer users.

12. The application software navigation system of claim 4, wherein said One-Touch OS application software system provides game playing t o computer users.

13. The application software navigation system of claim 4, wherein said One-Touch OS application software system provides multimedia playback.

14. The data exchange system of claim 4, wherein said One-Touch OS application software system is capable of processing handy personal information including phone numbers and addresses, taking notes in texts and in drawings, providing communication services including telephone connections, facsimile transmissions and receptions, electronic mailing, chatting service over the Internet, accessing the World Wide Web over the Internet, providing language tutoring and typing tutoring to computer users, providing game play to computer users, and providing audio and video playback.

15. An intuitive single key-press navigation system for operating a computer running an application software program by a user under a host operating system, said navigation system comprising:
a user interface comprising a user interface module for providing interface between said computer and said user by issuing interface requests during the use of said application software program by said user; said user issuing said interface requests by pressing a single key on the keyboard of said computer responding to discrete options menus presented to said user by said application software program; and
a kernel unit comprising an interface database module for storing text-based program options information for said application software program; an interface graphics module for storing graphics information for said application software program; an interface response module for receiving said interface requests issued by said user; and an interface generator module receiving said text-based program option information and said graphics information and generating visual-effect symbols of push buttons displayed on the screen of said computer for presenting to said user based on said text and graphics information under said issued interface requests.

16. The application software navigation system of claim 15, wherein said application software program is a user-friendly application software system incorporating a plurality of simple interfaces for intuitive access by computer users.

17. In a computer running an application software program by a user under a host operating system, said application software program comprising a user interface and a kernel unit; said user interface comprising a user interface module for providing interface between said computer and said user by issuing interface requests during the use of said application software program by said user; and said kernel unit comprising an interface database module for storing text-based program options information for said application software program; an interface graphics module for storing graphics information for said application software program; an interface response module for receiving said interface requests issued by said user; and an interface generator module receiving said text-based program option information and said graphics information; an intuitive single key-press navigation method for navigating said computer comprising the steps of:
generating a menu of options containing a plurality of visual-effect symbols each representing one of said options based on said text and graphics information under said issued interface requests for selection by said user;
said user selecting one of said options by performing a single key-press selection by pressing a single key on the keyboard of said computer; and
navigating through said application software program by implementing said single key-press selection at least one time.

18. The method of intuitive single key-press navigation of claim 17, wherein said step of navigating through said application software program by implementing said single key-press selection further comprises the step of selecting in a major program loop, wherein said major program loop providing options to said user including a group of major functional category of said application software program.

19. The method of intuitive single key-press navigation of claim 18, further comprises the step of selecting in a sub program loop, wherein said sub program loop providing options to said user including a group of sub-functional category of said application software program.

20. The method of intuitive single key-press navigation of claim 17, wherein said visual-effect symbols are representations of push buttons displayed on the screen of said computer.

21. The method of intuitive single key-press navigation of claim 17, wherein said application software program is a user-friendly application software system incorporating a plurality of simple interfaces for intuitive access by computer users.

22. The method of intuitive single key-press navigation of claim 21, wherein said application software program is a user-friendly One-Touch OS application software system for processing daily-life computer applications for computer users.

23. The method of intuitive single key-press navigation of claim 21, wherein said One-Touch OS application software system processes handy personal information including phone numbers and addresses.

24. The method of intuitive single key-press navigation of claim 21, wherein said One-Touch OS application software system takes notes.

25. The method of intuitive single key-press navigation of claim 21, wherein said One-Touch OS application software system provides communication services.

26. The method of intuitive single key-press navigation of claim 21, wherein said One-Touch OS application software system provides chatting service over the Internet.

27. The method of intuitive single key-press navigation of claim 21, wherein said One-Touch OS application software system provides access to the World Wide Web over the Internet.

28. The method of intuitive single key-press navigation of claim 21, wherein said One-Touch OS application software system provides language tutoring to computer users.

29. The method of intuitive single key-press navigation of claim 21, wherein said One-Touch OS application software system provides typing tutoring to computer users.

30. The method of intuitive single key-press navigation of claim 21, wherein said One-Touch OS application software system provides game playing to computer users.

31. The method of intuitive single key-press navigation of claim 21, wherein said One-Touch OS application software system provides multimedia playback.

32. The method of intuitive single key-press navigation of claim 21, wherein said One-Touch OS application software system is capable of processing handy personal information including phone numbers and addresses, taking notes in texts and in drawings, providing communication services including telephone connections, facsimile transmissions and receptions, electronic mailing, chatting service over the Internet, accessing the World Wide Web over the Internet, providing language tutoring and typing tutoring, providing game playing, and providing audio and video playback.
